(19) United States
(12) Patent Application Publication
(10) Pub. No.: US 2009/0126646 A1
(43) Pub. Date: May 21, 2009

(54) Nest box system and egg collection apparatus

(76) Inventor: David Anthony Johnston, New South Wales (AU)

Correspondence Address: BROOKS KUSHMAN P.C., 1000 TOWN CENTER, TWENTY-SECOND FLOOR, SOUTHFIELD, MI, 48075, US

(21) Appl. No.: 11/911,738

(22) PCT Filed: Apr. 19, 2005
(86) PCT No.: PCT/AU05/00555

§ 371 Date: Oct. 17, 2007

(51) Int. Cl. A01K 31/16

(52) U.S. Cl. 119/338; 119/337; 119/347

(57) ABSTRACT

A nest box system (10) having a plurality of nest boxes (12) for egg-laying birds, including a pair of substantially parallel sidewalls (14, 14) forming sides of the nest boxes (12), and divider walls (16) mounted to the sidewalls (14, 14) at spaced intervals for forming dividers between adjacent nest boxes (12), the nest box system (10) being adapted for use with a floor (18) separable from the nest box system (10), wherein the sidewalls (14, 14) are deformable upwardly/downwardly so as to adapt to changes in profile of the floor (18) for preventing litter escaping the nest boxes (12) through unwanted self-lifting of the sidewalls (14, 14) above the floor (18).

### FIELD OF THE INVENTION

This invention relates to nest boxes for egg-laying birds and an egg collection apparatus. More particularly but not exclusively, the invention relates to a nest box system having adjustable nest size, and being suitable for automatic and/or manual egg collection in broiler breeders, free range and/or barn range egg production.

### BACKGROUND OF THE INVENTION

It has been previously proposed to provide an egg harvester for collecting eggs of laying hens or the like in which there is a series of nest boxes for containing the hens while eggs laid by the hens are collected by a shuttle running underneath the nest boxes.

Many previous mechanical nest box systems are not able to use litter as they rely on rolling of eggs to operate correctly, and it is not possible for eggs to roll freely when a nesting floor is lined with litter. However, it is desirable to use litter on the floor of nest boxes, as the use of litter is known to result in a higher quality egg. It has been found that where litter is not used hens instead lay eggs on the ground. Eggs laid on the ground are particularly susceptible to contamination and/or breakage, and require manual gathering.

Mechanical and automatic nest systems using litter are described in U.S. Pat. No. 5,562,067, AU-A-14782/95 and WO 02/091819, and the contents of these documents are incorporated herein by reference. The litter nest boxes described in U.S. Pat. No. 5,562,067 and AU-A-14782/95 are arranged in pairs, in adjoining relationship with hingedly interconnected sidewalls. In this design, each nest box has multiple hinge points. In a typical commercial poultry shed where the nest zone can be in excess of 100 metres in length, this equates to many hundreds of hinge points, each prone to jamming or failure. Moreover, the type of nest boxes disclosed in these references are not adjustable in size, are time-consuming to assemble, and require regular maintenance and inspection.

The nest boxes described in WO 02/091819 also have a hingedly interconnected design. Adjoining nest boxes rely on a “pin-and-slot” arrangement for relative movement between the nest boxes, such as when the boxes begin an incline or a decline. A nesting system built on a large scale in accordance with this design may have many hundreds of hinge points, prone to failure and jamming.

The addition of extra sidewall portions, as in WO 02/091819, can also lead to the nest sidewalls forming a “sawtooth” pattern. This occurs when one section of sidewall tilts upwards, the next section tilts downwards, the following section tilts upwards, and so on. When this “sawtooth” pattern occurs, the nest wall does not form a seal with the nest floor, and nest litter escapes from the nests. As a result, the nests require frequent topping up with new litter, thus increasing labour requirements and consumption of litter, particularly when there are hundreds of nests in a laying zone.

In WO 02/091819, egg collection and litter cleaning is achieved by rod conveyors, bridges, scrapers, waste trays and guides. This configuration is very prone to jamming by just about any foreign object entering the nest litter, in particular pieces of wood in the litter and toe balls. A toe ball is a very hard ball of organic material which forms around chicken's toes, which when dislodged are like small rocks.

With reference to FIGS. 2 and 3 of this reference, the nest mat is deflected downwardly after entering the collection shuttle. The litter then falls through conveyor rods and returns to the mat before making its way up an incline and leaving the shuttle. The nest mat is typically a plastic type material approximately 1 mm thick and has to be kept at the correct tension so that this departing incline does not sag. If sagging occurs, the litter will fall back into the machine and the machine will not work. This tensioning is achieved by spring loading circular rollers to tension the mat, however this wears grooves in the mat over a relatively short period of time. In addition to the wear itself, these grooves tend to ‘pop back’ when moving over rollers in the machine, causing litter to be ejected from the machine. Mat expansion and contraction with temperature variations also exacerbate the tensioning problem. If the mat tension is set too tight, the internal changeover mechanism on the machine will not work and the machine will not function.

Examples of the present invention seek to provide an improved nest box system for an egg collection apparatus which overcomes or at least alleviates one or more of the above disadvantages.

### SUMMARY OF THE INVENTION

In one aspect there is provided a nest box system having a plurality of nest boxes for egg-laying birds, including a pair of substantially parallel sidewalls forming sides of the nest boxes, and divider walls mounted to the sidewalls at spaced intervals for forming dividers between adjacent nest boxes, the nest box system being adapted for use with a floor separable from the nest box system, wherein the sidewalls are deformable transversely of the floor.

Preferably, the sidewalls are deformable upwardly/downwardly so as to adapt to changes in profile of the floor for preventing litter escaping the nest boxes through unwanted self-lifting of the sidewalls above the floor.

Preferably, the floor separates from the nest box system as it enters a shuttle for processing of litter and eggs on the floor, the nest box system rides over the top of the shuttle, and the floor rejoins the nest box system as it exits the shuttle. The upward/downward deformability of the sidewalls enables the sidewalls to adapt to changes in profile of the floor either side of the shuttle for preventing litter escaping the nest boxes through unwanted self-lifting of the sidewalls above the floor surface either end of the shuttle.

Preferably, the divider walls are able to be mounted to the sidewalls at different locations along the length of the sidewalls so as to provide nest boxes of adjustable size(s).

In another aspect, there is provided a nest box system having a plurality of nest boxes for egg-laying birds, including a pair of substantially parallel sidewalls forming sides of the nest boxes, and divider walls removably mountable between the sidewalls at spaced intervals along the length of the sidewalls for forming dividers between adjacent nest boxes.

Preferably, each of the sidewalls is a single unitary piece extending the full length of the nest box system.

In yet another aspect there is provided an automatic egg collection apparatus including a shuttle adapted to move along a nest box system to collect eggs laid in nest boxes of the nest box system, wherein a floor of the nest boxes separates from the nest box system for entering the shuttle while the nest box system rides over the top of the shuttle, wherein the floor defines a path which travels through the shuttle from the entry to a lower level whereby litter carried into the shuttle on the floor is dropped to the lower level for aeration, the floor subsequently travelling gradually upward to the exit so as to avoid litter moving backwards along the floor.

In yet another aspect there is provided an automatic egg collection apparatus including a shuttle adapted to move along a nest box system to collect eggs laid in nest boxes of the nest box system, wherein a floor of the nest boxes separates from the nest box system for entering the shuttle while the nest box system rides over the top of the shuttle, wherein the floor defines a path which travels through the shuttle from the entry to an elevated upper level and then to a lower level whereby litter carried into the shuttle on the floor is dropped from the upper level to the lower level for aeration, the floor subsequently travelling to the exit to rejoin the nest box system.

Preferably, the shuttle includes a convexly curved support for supporting the nest box system as it rides over the top of the shuttle.

Preferably, the convexly curved support includes a weighing device for weighing birds as they ride over the top of the shuttle in the nest boxes.

Preferably, the shuttle has a ramp which raises the floor entering the shuttle to sliding rods between which the litter drops, and along which the eggs slide to a transverse conveyor for transporting the eggs laterally of the nest box system. More preferably, when a direction of the shuttle is reversed, the ramp is lowered to a horizontal position and an opposed ramp on an opposite side of the transverse conveyor is raised for raising the floor entering the shuttle to the sliding rods.

### BRIEF DESCRIPTION OF THE DRAWINGS

The invention is described, by way of non-limiting example only, with reference to the accompanying drawings in which:

FIG. 1 is a diagrammatic top perspective view of a nest box system;

FIG. 2 is a cross-sectional end view of the nest box system of FIG. 1;

FIG. 3 is a diagrammatic top view of two nest box systems shown in parallel in a shed;

FIG. 4 is a diagrammatic side view of an automatic egg collection apparatus for use with the nest box systems of FIGS. 1 to 3;

FIG. 5 is a detailed diagrammatic side view of a shuttle of the automatic egg collection apparatus of FIG. 4; and

FIG. 6 is a diagrammatic top view of the shuttle of FIG. 5.

### DETAILED DESCRIPTION

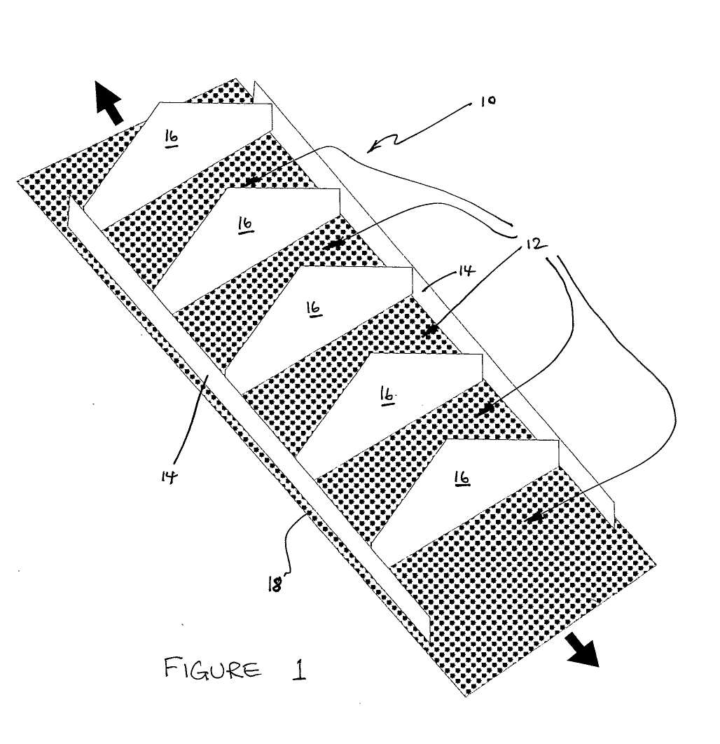

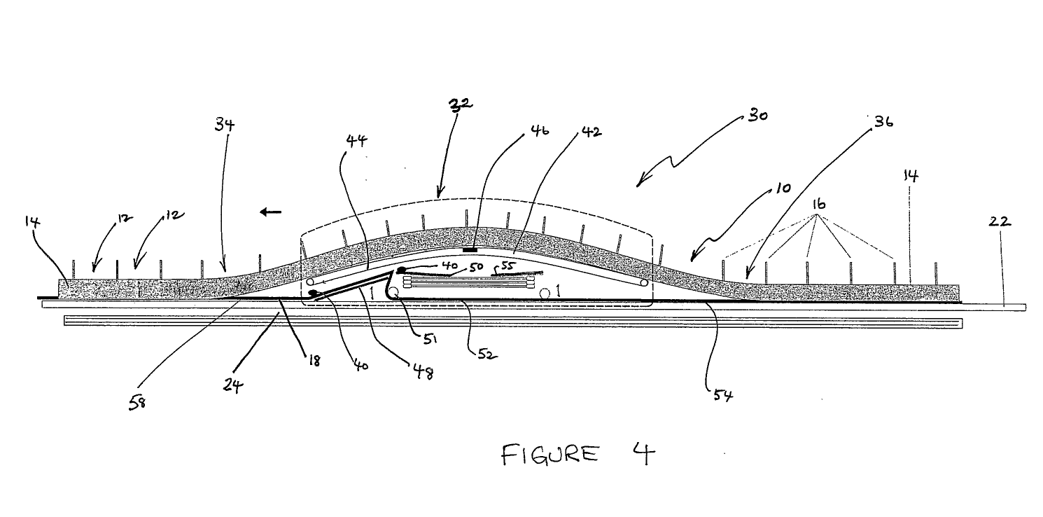

FIG. 1 shows a nest box system 10 having a plurality of nest boxes 12 for egg-laying birds. The nest box system 10 includes a pair of substantially parallel sidewalls 14 forming sides of the nest boxes 12, and divider walls 16 mounted to the sidewalls 14 at spaced intervals for forming dividers between adjacent nest boxes 12. The nest box system 10 is adapted for use with a floor 18 which is separable from the nest box system 10, and the sidewalls 14 are deformable upwardly/downwardly (see FIG. 4) so as to adapt to changes in profile of the floor 18 for preventing litter escaping the nest boxes 12 through unwanted self-lifting of the sidewalls 14 above the floor 18.

Litter used on the nesting floor may be in the form of wood shavings, sawdust or the like.

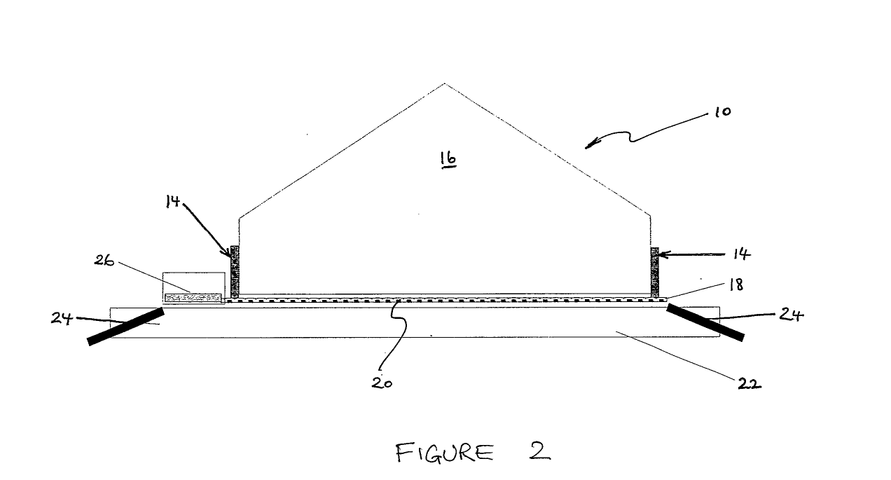

With reference to FIG. 2, the nest box system 10 is supported by the floor 18 which is in the form of a flexible mat 20, and the flexible mat is, in turn, supported by a frame 22 which is substantially horizontal and extends for the length of the nest box system 10. The frame 22 also supports elongated entry platforms 24 (or “perches”) along either side of the nest box system 10 to facilitate entry/exit of birds to/from the nest boxes 12. In one form, the entry platforms 24 may comprise mesh or spaced rods or bars. The nest box system 10 may be used with either manual or automatic egg collection methods. Manual egg collection methods involve a person manually collecting the eggs laid in each nest box 12, and for that reason is known to be relatively slow. Automatic egg collection methods are becoming more widely used, and an apparatus for performing automatic collection of eggs will be described in greater detail below. FIG. 2 shows a longitudinal egg conveyor 26 mounted alongside the nest box system 10 for conveying eggs collected from the nest boxes 12 for further processing. The egg conveyor 26 extends along the length of the nesting zone.

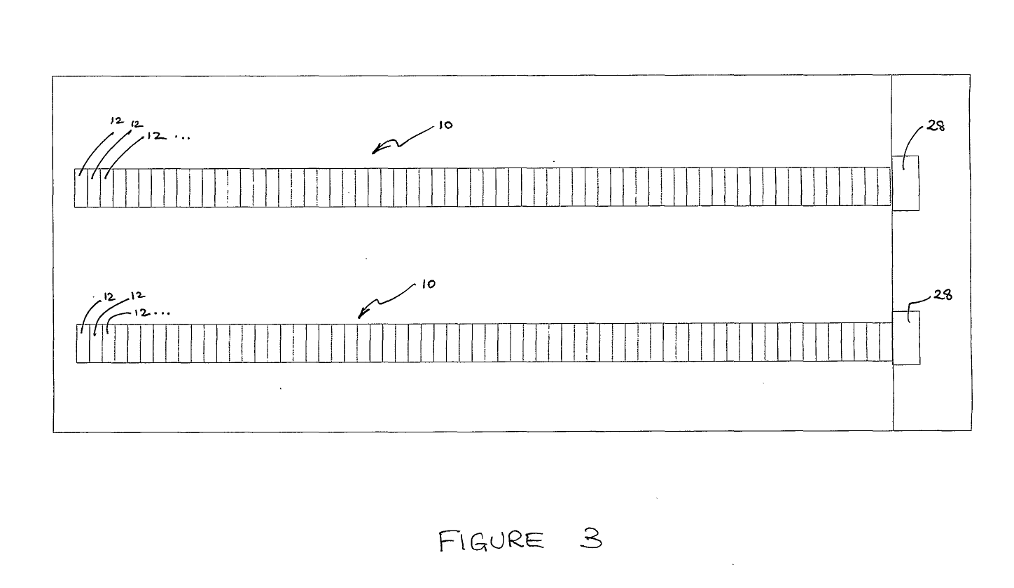

FIG. 3 shows a diagrammatic representation of two rows of nest box systems 10 mounted side-by-side in a shed. As illustrated, there may be many nest boxes 12 which form the nest box system 10. A station 28 for further processing of the eggs may be provided at an end of each of the nest box systems 10. The stations 28 may be in the form of collection tables.

The nest box systems 10 shown in FIGS. 1 to 3 are suitable for use with an automatic egg collection apparatus 30 as shown in FIGS. 4 to 6, having a shuttle 32 adapted to move along the nest box system 10 to collect eggs laid in the nest boxes 12.

With reference to FIG. 4, the floor 18 separates from the nest box system 10 around location 34 as it enters the shuttle 32 for processing of litter and eggs on the floor 18. The nest box system 10 rides over the top of the shuttle 32, and the floor 18 rejoins the nest box system 10 around location 36 as it exits the shuttle 32. The upward/downward deformability of the sidewalls 14 enable the sidewalls 14 to adapt to changes in profile of the floor 18 either side of the shuttle 32 for preventing litter escaping the nest boxes 12 through unwanted self-lifting of the sidewalls 14 above the floor 18 either side of the shuttle 32. Advantageously, while the deformability of the sidewalls 14 prevents unwanted lifting of the nest box system 10 relative to the floor 18, which occurs in previous systems by way of “sawtoothing” and/or jamming of pivot joints between rigid articulated sidewall components, it still allows separation of the nest box system 10 from the floor 18 as is necessary for operation of the shuttle 32. By virtue of the deformability of the sidewalls 14, the nest box system 10 is able to bend upwardly and over the shuttle 32, as shown in FIG. 4.

The divider walls 16 are able to be mounted to the sidewalls 14 at different locations along the length of the sidewalls 14 so that their placement can be tailored to achieve a desired nest box size. By virtue of the deformability of the sidewalls 14, there is no need for pivot points in the sidewalls 14 and thus the nest box system 10 may have no moving parts. That is, the nest box system 10 may be manufactured such that no parts of the nest box system 10 pivot or slide with respect to other parts of the nest box system 10 during normal use. In the example shown, this is achieved by way of each of the sidewalls 14 being a single unitary piece extending the full length of the nest box system 10.

As there are no constraints regarding placement of nest box dividers at or between specific pivot points of the sidewalls 14, the divider walls 16 may be mounted anywhere along the length of the sidewalls 14. This feature may be used to advantage for tailoring the size of the nest boxes 12 to suit different sizes of bird (eg. for different breeds) or may be used to create nest boxes 12 of different sizes within the one nest box system 10. The nest boxes 12 may be sized to fit a number of birds within each nest box 12 or, more preferably, may be sized to accommodate a single bird per nest box 12. The divider walls 16 may be made removable and re-attachable from/to the sidewalls 14 by way of known kinds of attachment means such as, for example, clips, slots, etc.

The divider walls 16 form dividers between adjacent nest boxes 12 and serve several functions including containing litter within the separate nest boxes 12, providing privacy for the birds, and preventing movement of the birds along the nest box system 10 during operation of the shuttle 32.

An example of an automatic egg collection apparatus 38 with which the nest box system 10 may be used is shown in FIGS. 4 to 6. The automatic egg collection apparatus 38 includes the shuttle 32 adapted to move along the nest box system 10 to collect eggs 40 laid in the nest boxes 12 of the nest box system 10. The floor 18 of the nest boxes 12 separates from the nest box system 10 as it enters the shuttle 32 for processing of litter (not shown) and eggs 40 on the floor 18, and the nest box system 10 rides over the top of the shuttle 32.

In the example shown, the top of the shuttle 32 is provided with a convexly curved support 42 having a conveyor belt 44 which rotates so that an upper side of the belt 44 is substantially stationary relative to the floor 18 at either side of the shuttle 32. This means that the birds in the nest boxes 12 are not required to walk as the shuttle 32 is moving beneath them.

By virtue of the deformability of the sidewalls 14, the nest box system 10 is able to adapt to the profile of the convexly curved support 42 which effectively provides a floor surface to the nest boxes 12 under which the shuttle 32 is moving.

The convexly curved support 42 may include a weighing device 46 for weighing birds as they ride over the top of the shuttle 32 in the nest boxes 12. Advantageously, this enables a user to conveniently monitor the weight of the birds, and this may be of assistance in monitoring feed, bird health and disease.

The automatic recording of individual bird weights and location in the nesting zone is an invaluable tool in assessing the overall health and performance of the flock and in any identifying any problem areas in the nesting zone.

In one example the automatic egg collection apparatus 30 may be controlled by an on-board computer. It is powered by electric motors and, through sensors, knows its position along the nest zone and the status of its various components. Load cells installed below the surface of the rotating conveyor belt 44 weigh individual birds as they pass over the shuttle 32. The on-board computer records these weights and through the use of “rfid” technology may tag these weights to individual birds. In a variation, a load cell or strain gauge may be placed below the conveyor belt 44 to obtain the average weights for groups of birds. A radio frequency identification reader can be placed near this point for the purpose of reading id devices attached to individual birds. In this way, the weights of individual birds can be recorded and compared over time.

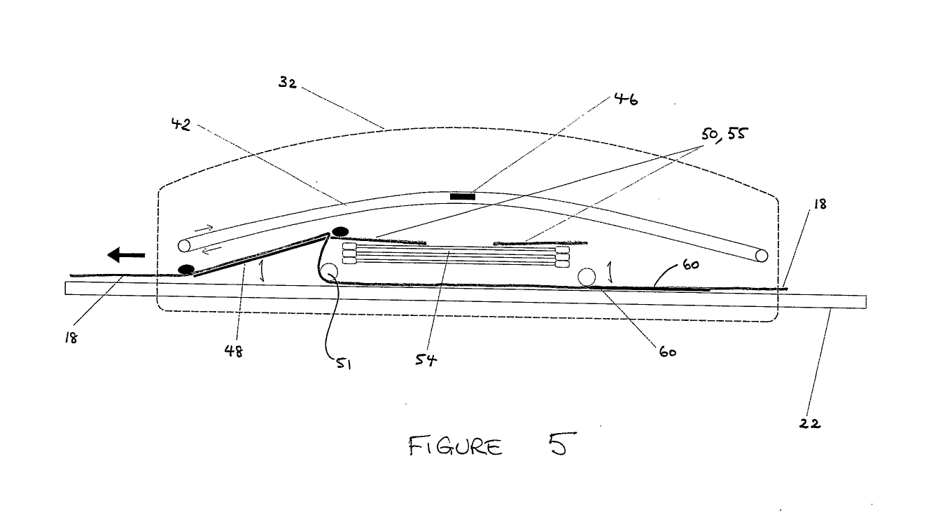

With reference to the more detailed diagram in FIG. 5, after running the floor 18 up a gradual ramp 48 to an elevated level at sliding rods 50, the shuttle 32 deflects the floor 18 downwardly to a lower level to cause litter to fall from the floor 18. The shuttle 32 subsequently deflects the floor 18, by way of a roller 51, into a substantially horizontal portion 52 on which the falling litter lands, thus aerating the litter. The substantially horizontal portion 52 of floor is at the same level as a trailing portion 54 of the floor 18 behind the shuttle 32 such that the horizontal portion 52 simply continues horizontally through the shuttle 32 and into the trailing portion 54. Meanwhile, the eggs 40 carried upwardly along the gradual ramp 48 by the litter are transferred onto the sliding rods 50 along which they slide to a transverse conveyor 54. The litter carried by the floor 18 up the gradual ramp 48 falls through gaps between the sliding rods 50, downwardly to the horizontal portion 52, as described above.

During operation of the shuttle 32, the litter may fall back onto the horizontal portion 52 of floor via the sliding rods 50 or the transverse rod conveyor 54 at any time. Advantageously, the floor remaining horizontal or substantially horizontal once deflected by the roller 51 assists in preventing litter from becoming trapped within the shuttle 32 by moving backward along the floor, as has been the case in previous apparatus wherein the floor exits the shuttle at a steep upward incline.

The convex curvature of the convexly curved support 42 accommodates the lack of incline in the floor 18 after the roller 51 by curving back down to a point where the birds riding on the conveyor belt 44 are able to be transferred easily and with only a small drop onto the trailing portion 54. As the support 22 is the same over the length of the nest box system 10, a leading portion 58 of the floor 18 in front of the shuttle 32 is at the same level as the trailing section 54.

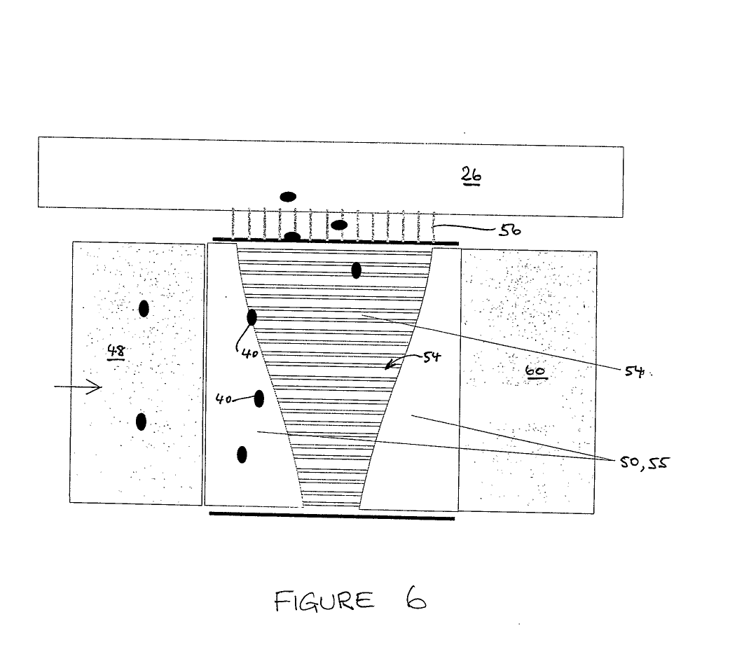

With reference to FIG. 6, the sliding rods 50 are of different lengths such that the ends of the rods 50 form a line which, combined with a line of opposed sliding rods 55 on an opposite side of the transverse conveyor 54, form a broadened egg path in the direction in which the transverse conveyor 54 moves. This configuration of the sliding rods 50 assists in distributing the eggs 40 across the width of the transverse conveyor so as to assist in spreading flow of eggs along the longitudinal egg conveyor 26 to which the transverse conveyor 54 feeds. The eggs 40 are passed from the transverse conveyor 54 to the longitudinal egg conveyor 26 via a grate 56 which allows droppings to fall through. More particularly, pieces of manure which were in the nest but were large enough to not fall with the litter back to the nest mat are transported by the transverse conveyor 54 towards the grate 56 where they fall out onto the ground, thereby cleaning the nests of manure and other foreign objects.

The sliding rods 50 may vibrate to encourage movement of the eggs 40. In an alternative example, the sliding rods 50 may be in the form of a vibrating or non-vibrating plate, in which case the litter will move along the plate to the transverse conveyor 54, at which stage the litter will fall between the bars of the transverse conveyor 54 and onto the substantially horizontal portion 52 of the floor 18 below.

When the shuttle 32 gets to one end of the nest box system 10, the next run of the shuttle 32 is able to be made in the opposite direction by simply lowering the ramp 48 to a horizontal configuration and raising an opposed ramp 60 on an opposite side of the transverse conveyor 54 from the horizontal configuration shown in FIGS. 4 and 5 to a raised configuration. This accounts for the change in direction of the incoming eggs, litter and droppings to the shuttle 32.

Accordingly, the automatic egg collection apparatus 30 provides a bi-directional system which collects eggs laid in the nest boxes 12, and returns to the nest boxes 12 litter which has been cleaned and aerated.

It will be readily apparent to the skilled addressee that the flexible side wall design of the above described example overcomes the problems associated with previous multiple hinge designs. It also overcomes the problem of litter loss in earlier hinged colony nests designs by forming an effective seal between the nest wall and the nest.

The example nest box system 10 described above is a major advance on these earlier litter nests and their variants, as it has no moving parts and totally eliminates the need for hinges, pivot pins etc. It eliminates the loss of litter problems due to ‘sawtoothing’ of the nest wall associated with the device disclosed in WO 02/091819.

This design also allows for variable nest sizes to cater for different sizes and varieties birds.

In the above example, the nest contents minus the bird are transferred from the nest floor 18 to the spaced rod transverse conveyor 54, which transfers the eggs 40 to the egg conveyor 26 via a plurality of spaced rods in the form of the grate 56. There are no catch or jam points. In comparison to WO 02/091819 the elimination of the guides, finger wheels, transfer bridges, rattlers, the waste tray and the waste scrapers allows a significant reduction in size and components, it also eliminates jamming associated with foreign objects in the litter such as toe balls. Existing machines based on the device disclosed in WO 02/091819 are typically over 600 kg in weight and are up to 7 metres long. The present design typically weighs less than 80 kg, and is less than 2 metres in length.

One of the main incentives for poultry farmers both in the breeder and commercial egg segments of the industry to automate operations, is the reduction in labour and its associated costs. But if the equipment is unreliable and uses large amounts of consumables eg. litter, these advantages are lost.

Other advantages include that:
the collection apparatus separates eggs, aerates nest litter and removes manure from litter nests;
the collection apparatus and nest box system are not prone to jamming;
the nest box system conserves litter;
performance of the collection apparatus and nest box system is not affected by the expansion and contraction of the mat which forms the nest floor;
the collection apparatus is capable of processing all the eggs and litter in the nests without blocking; and
the collection apparatus is compact in size to allow easy cleaning at the end of the flock.

The above examples have been described by way of example only and modifications are possible within the scope of the invention.

The reference to any prior art in this specification is not, and should not be taken as, an acknowledgment or any form of suggestion that that prior art forms part of the common general knowledge in Australia.

Throughout this specification and the claims that follow, unless the context requires otherwise, the word “comprise”, or variations such as “comprises” or “comprising”, will be understood to imply the inclusion of a stated step or integer or group of steps or integers but not the exclusion of any other step or integer or group of steps or integers.

1. A nest box system having a plurality of nest boxes for egg-laying birds, including a pair of substantially parallel sidewalls forming sides of the nest boxes, and divider walls mounted to the sidewalls at spaced intervals for forming dividers between adjacent nest boxes, the nest box system being adapted for use with a floor separable from the nest box system, wherein the sidewalls are deformable transversely of the floor.

2. A nest box system as claimed in claim 1, wherein the sidewalls are deformable upwardly/downwardly so as to adapt to changes in profile of the floor for preventing litter escaping the nest boxes through unwanted self-lifting of the sidewalls above the floor.

3. A nest box system as claimed in claim 1, wherein the nest box system is for use in an automatic egg collection apparatus having a collection unit adapted to move along the nest box system to collect eggs laid in the nest boxes.

4. A nest box system as claimed in claim 3, wherein the floor separates from the nest box system as it enters the collection unit for processing of litter and eggs on the floor, the nest box system rides over the top of the collection unit, and the floor re joins the nest box system as it exits the collection unit, and wherein the upward/downward deformability of the sidewalls enable the sidewalls to adapt to changes in profile of the floor either side of the collection unit for preventing litter escaping the nest boxes through unwanted self-lifting of the sidewalls above the floor either side of the collection unit.

5. A nest box system as claimed in claim 1, wherein the floor includes a flexible mat.

6. A nest box system as claimed in claim 1, wherein the divider walls are able to be mounted to the sidewalls at different locations along the length of the sidewalls so as to provide nest boxes of adjustable size(s).

7. A nest box system having a plurality of nest boxes for egg-laying birds, including a pair of substantially parallel sidewalls forming sides of the nest boxes, and divider walls separately moveable between the sidewalls and located at spaced intervals along the length of the sidewalls for forming dividers between adjacent nest boxes.

8. A nest box system as claimed in claim 7, wherein the nest box system is for use in an automatic egg collection apparatus having a collection unit adapted to move along the nest box system to collect eggs laid in the nest boxes.

9. A nest box system as claimed in claim 7, wherein relative positioning of the divider walls is adjustable so as to provide nest boxes of variable size(s).

10. A nest box system as claimed in claim 1, wherein the nest box system has no moving parts.

11. A nest box system as claimed in claim 1, wherein each of the sidewalls is a single unitary piece extending along a plurality of the nest boxes.

12. An automatic egg collection apparatus including a collection unit adapted to move along a nest box system to collect eggs laid in nest boxes of the nest box system, wherein a floor of the nest boxes rests at a normal level remotely of the collection unit, the floor separates from the nest box system for entering the collection unit while the nest box system rides on an upper support over the top of the collection unit, the floor defining a path which travels through the collection unit from the entry to an elevated upper level and then to a lower level receiving portion at or near said normal level whereby litter carried into the collection unit on the floor is dropped from the upper level to the receiving portion for aeration, the path subsequently travelling substantially horizontally from the receiving portion to the exit for the floor to rejoin the nest box system at or near said normal level.

13. An automatic egg collection apparatus including a collection unit adapted to move along a nest box system to collect eggs laid in nest boxes of the nest box system, wherein a floor of the nest boxes separates from the nest box system for entering the collection unit while the nest box system rides on an upper support over the top of the collection unit, wherein the floor defines a path which travels through the collection unit from the entry to a lower level whereby litter carried into the collection unit on the floor is dropped to the lower level for aeration, the path subsequently travelling to the exit for the floor to rejoin the nest box system, wherein a region of the floor between the lower level and the exit rides on a support along its length to prevent sagging of said region.

14. An automatic egg collection apparatus including a collection unit adapted to move along a nest box system to collect eggs laid in nest boxes of the nest box system, wherein a floor of the nest boxes rests at a normal level remotely of the collection unit and the floor separates from the nest box system for entering the collection unit while the nest box system rides on an upper support over the top of the collection unit, wherein the floor defines a path which travels through the collection unit from the entry to an elevated upper level and then to a lower level receiving portion at or near said normal level whereby litter carried into the collection unit on the floor is dropped from the upper level to the receiving portion for aeration, the floor subsequently travelling to the exit to rejoin the nest box system, and wherein both a leading end and a trailing end of the upper support terminate sufficiently near to said normal level to enable egg-laying birds to step up onto the leading end of the upper support from the floor at said normal level and to step down from the trailing end of the upper support to the floor at said normal level.

15. An automatic egg collection apparatus including a collection unit adapted to move along a nest box system to collect eggs laid in nest boxes of the nest box system, wherein a floor of the nest boxes rests at a normal level remotely of the collection unit, the floor separates from the nest box system for entering the collection unit while the nest box system rides on an upper support over the top of the collection unit, the floor defining a path which travels through the collection unit from an entry at said normal level to an exit at said normal level, wherein the path has only a single inclined portion, that being an inclined portion from the entry to an elevated upper level from where litter is dropped onto a subsequent receiving portion for aeration, the path subsequently travelling from the receiving portion to the exit for the floor to rejoin the nest box system.

16. An automatic egg collection apparatus as claimed in claim 13, wherein a region of the floor between the lower level and the exit is horizontal or substantially horizontal so as to avoid litter moving backwards along the floor.

17. An automatic egg collection apparatus as claimed in claim 12, wherein the upper support is convexly curved for supporting the nest box system as it rides over the top of the collection unit, the convexly curved support raising the nest box system from the floor in front of the collection unit, over the collection unit, and back down to the floor behind the collection unit.

18. An automatic egg collection apparatus as claimed in claim 17, wherein the convexly curved support includes a weighing device for weighing birds as they ride over the top of the collection unit in the nest boxes.

19. An automatic egg collection apparatus as claimed in claim 18, wherein the nest boxes are sized to contain multiple birds per nest box.

20. An automatic egg collection apparatus as claimed in claim 18, wherein the apparatus is provided with a device for identification of the birds for use in processing weight data of the birds.

21. An automatic egg collection apparatus as claimed in claim 20, wherein the device for identification of the birds uses radio frequency transmission.

22. An automatic egg collection apparatus as claimed in claim 12, wherein the floor is at the same level at all points along its length, except for a raised portion between the entry to the collection unit and the receiving portion.

23. An automatic egg collection apparatus as claimed in claim 22, wherein the upper support is convexly curved for supporting the nest box system as it rides over the top of the collection unit, the convexly curved support raising the nest box system from the floor in front of the collection unit, over the collection unit, and back down to the floor behind the collection unit, and wherein the convexly curved support includes a conveyor belt rotating so that an upper side of the belt is substantially stationary relative to the leading and trailing portions of the floor.

24. An automatic egg collection apparatus as claimed in claim 12, wherein the nest box system comprises a plurality of nest boxes for egg-laying birds, including a pair of substantially parallel sidewalls forming sides of the nest boxes, and divider walls mounted to the sidewalls at spaced intervals for forming dividers between adjacent nest boxes, the nest box system being adapted for use with a floor separable from the nest box system, wherein the sidewalls are deformable transversely of the floor.

25. An automatic egg collection apparatus as claimed in claim 12, wherein the apparatus is provided with an elongated entry platform along either side of the nest box system to facilitate entry/exit of birds to/from the nest boxes.

26. An automatic egg collection apparatus as claimed in claim 12, wherein the collection unit has a ramp which raises the floor entering the collection unit to sliding rods between which the litter drops, and along which the eggs slide to a transverse conveyor for transporting the eggs laterally of the nest box system.

27. An automatic egg collection apparatus as claimed in claim 26, wherein when a direction of the collection unit is reversed, the ramp is lowered to a horizontal position and an opposed ramp on an opposite side of the transverse conveyor is raised for raising the floor entering the collection unit to the sliding rods.
